(19) United States
(12) Patent Application Publication
(10) Pub. No.: US 2025/0280057 A1
(43) Pub. Date: Sep. 4, 2025

(54) SYSTEMS AND METHODS FOR MONITORING EXTERNAL DATA SHARING

(71) Applicant: Capital One Services, LLC, McLean, VA (US)

(72) Inventors: Shitij KULSHRESHTHA, Glen Allen, VA (US); Richard BEHARRY, Larchmont, NY (US); Biswajit BISWAL, North Andover, VA (US); Abhishek GHOSH, Glen Allen, VA (US); David James WEAVER, Woodstown, NJ (US); Ramesh JITTA, Ashburn, VA (US)

(73) Assignee: Capital One Services, LLC, McLean, VA (US)

(21) Appl. No.: 18/592,071

(22) Filed: Feb. 29, 2024

(51) Int. Cl. H04L 67/53; H04L 9/40; H04L 67/1095; H04L 67/561

(52) U.S. Cl. CPC H04L 67/53; H04L 63/12; H04L 67/1095; H04L 67/561

(57) ABSTRACT

Systems and methods for monitoring external data sharing are provided and can be used to detect drift in metadata of a data share, volume and frequency anomalies, and/or drift in attribute level data. For example, some methods can include receiving baseline metadata and transmission details for a data transmission and determining whether there is conformity therebetween. Some methods can include receiving historical volume and frequency data, identifying a data transmission for external transmission, and determining whether a volume of the data transmission conforms with the historical volume and frequency data and whether a time at which the data transmission is transmitted or scheduled to be transmitted to a third party conforms with the historical volume and frequency data. Some methods can include receiving design time data, identifying a data transmission for external transmission, and determining whether runtime data for the data transmission conforms with the design time data.

### BACKGROUND

It is well known to share data between two parties, for example, between a data producer and a data consumer. However, known systems and methods do not include a central source of data that has been approved to be shared externally. Indeed, sources of data often have poor data quality, are stale, and/or are not widely available or trusted. In this regard, steps to share the data are often unclear, duplicative, and have many entry points. Furthermore, there are no known systems and methods to monitor whether a share is compliant with what has been contracted or allowed to be shared.

### BRIEF SUMMARY

In some embodiments, a method can include receiving baseline metadata for a data transmission, receiving transmission details for the data transmission, determining whether the transmission details for the data transmission conforms with the baseline metadata for the data transmission, and when the transmission details for the data transmission fail to conform with the baseline metadata for the data transmission, transmitting an alert notification.

In some embodiments, the method can include determining whether the transmission details of the data transmission conform with the baseline metadata for the data transmission prior to the data transmission being transmitted to a third party.

In some embodiments, the method can includes determining whether the transmission details for the data transmission conform with the baseline metadata for the data transmission after the data transmission is transmitted to a third party.

In some embodiments, the method can include receiving the baseline metadata for the data transmission upon registration of the data transmission for external transmission.

In some embodiments, the method can include receiving the baseline metadata for the data transmission upon creation of the data transmission in a database.

In some embodiments, the baseline metadata for the data transmission can include a transmission time, a name, a third party identification, a volume, a frequency, or a list of content attributes for the data transmission.

In some embodiments, the method can include determining whether a data share of the data transmission is authorized. For example, the method can include determining whether the data transmission has a valid permit authorizing the transmission details.

In some embodiments, a method can include receiving historical volume and frequency data, identifying a data transmission for external transmission, determining whether a volume of the data transmission conforms with the historical volume and frequency data, determining whether a time at which the data transmission is transmitted or scheduled to be transmitted to a third party conforms with the historical volume and frequency data, and when the volume of the data transmission fails to conform with the historical volume and frequency data or the time at which the data transmission is transmitted or scheduled to be transmitted to the third party fails to confirm with the historical volume and frequency data, transmitting an alert notification.

In some embodiments, the method can include receiving a mirrored copy of the data transmission.

In some embodiments, the method can include determining whether the volume of the data transmission conforms with the historical volume and frequency data prior to the data transmission being transmitted to the third party and determining whether the time at which the data transmission is scheduled to be transmitted to the third party conforms with the historical volume and frequency data prior to the data transmission being transmitted to the third party.

In some embodiments, the method can include determining whether the volume of the data transmission conforms with the historical volume and frequency data after the data transmission is transmitted to the third party and determining whether the time at which the data transmission is transmitted to the third party conforms with the historical volume and frequency data after the data transmission is transmitted to the third party.

In some embodiments, the method can include determining whether a data share of the data transmission is authorized. For example, in some embodiments, the method can include determining whether the data transmission has a valid permit for transmission thereof.

In some embodiments, a method can include receiving design time data, identifying a data transmission for external transmission, determining whether runtime data for the data transmission conforms with the design time data, and when the runtime data for the data transmission fails to conform with the design time data, transmitting an alert notification.

In some embodiments, the method can include receiving a mirrored copy of the data transmission.

In some embodiments, the method can include determining whether the runtime data for the data transmission conforms with the design time data while the data transmission is transmitted to a third party.

In some embodiments, the method can include determining whether the runtime data for the data transmission conforms with the design time data after the data transmission is transmitted to the third party.

In some embodiments, the design time data can include volume and frequency data for one or more application programming interfaces (APIs). As such, in some embodiments, the method can include determining whether the runtime data for transmitting the data transmission via the one or more APIs conforms with the volume and frequency data for the one or more APIs.

In some embodiments, a non-transitory computer-readable medium can include instructions that, when executed by a processor cause the processor to execute some or all of the above-identified methods.

In some embodiments, a computing device can include a processor and a memory storing instructions that, when executed by the processor, can cause the processor to execute some or all of the above-identified methods.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system in accordance with one embodiment.

FIG. 2 illustrates an example of a system in accordance with one embodiment.

FIG. 3 illustrates an example of a system in accordance with one embodiment.

FIG. 4 illustrates an example of a system in accordance with one embodiment.

FIG. 5 illustrates an example of a method in accordance with one embodiment.

FIG. 6 illustrates an example of a method in accordance with one embodiment.

FIG. 7 illustrates an example of a method in accordance with one embodiment.

FIG. 8 illustrates an example of a method in accordance with one embodiment.

FIG. 9 illustrates an aspect of a computer architecture in accordance with one embodiment.

FIG. 10 illustrates an aspect of a communications architecture in accordance with one embodiment.

### DETAILED DESCRIPTION

Embodiments disclosed herein are generally directed to systems and methods for monitoring external data sharing. Specifically, systems and methods disclosed herein can determine whether data that is shared matches data that is intended to be shared.

In accordance with disclosed embodiments, the data that is intended to be shared is known. In this regard, systems and methods disclosed herein can offer high quality, trustworthy, and fresh metadata about sharing relationships and publish such metadata for consumption, thereby becoming a source of truth for monitoring external data sharing. Similarly, the data that is actually shared is protected. In this regard, systems and methods disclosed herein can leverage shared metadata to (1) ensure an establishment of a transmission mechanism that matches an intent to share and (2) monitor data being shared to ensure that such data matches a share intent for each sharing instance. When a mismatch is identified, systems and methods disclosed herein can publish a notification thereof and initiate steps for remediation.

Advantageously, when external data sharing is monitored, technological and business risks can be reduced, and technological and business compliance can be increased. In this regard, when systems and methods disclosed herein determine that data that is shared matches data that is intended to be shared, systems and methods disclosed herein can confirm that the technology supporting such a share has not been compromised and that business data is secure. Similarly, when systems and methods disclosed herein determine that data that is shared fails to match data that is intended to be shared, systems and methods disclosed herein can provide notifications thereof and/or initiate actions to address such non-compliance, including, for example, identifying and executing technical changes to systems that support sharing the data.

A data share can include at least five core elements: (1) a data producer, (2) a channel, (3) a data consumer, (4) data, and (5) a business purpose. First, the data producer can include an owner of the data, such as, for example, a line of business (LOB) team for sharing the data in an outbound direction. Second, the channel can describe how the data is shared and include different mediums to exchange the data, including, for example, a stream, an external file gateway (EFG) for sharing the data with files, an application programming interface (API) gateway for real-time APIs, and a user data platform (UDP) for the data when including pixels or clickstreams. Third, the data consumer can describe who receives the data and can include a third party when the data is outbound. Next, the data can describe what is being shared and include, for example, APIs, elements, clickstream attributes, and identifications and fields in a data set. Finally, the business purpose can describe a business reason for why to share the data and include, for example, accounting services, maintenance, advertising, marketing, fraud detection, fraud prevention, and consumer reporting.

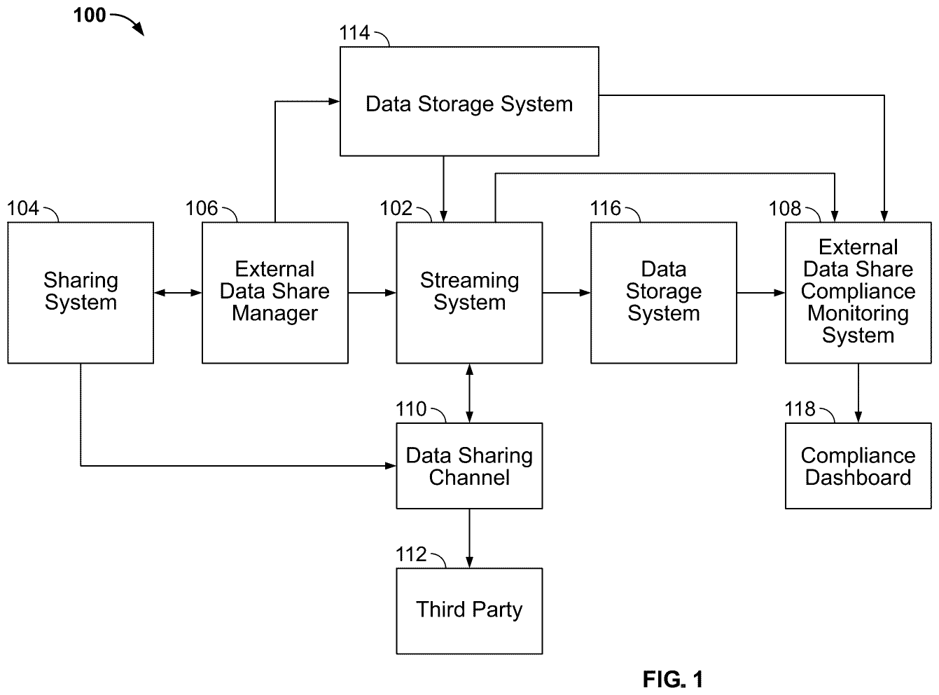

FIG. 1 is a block diagram that illustrates an example of a system 100 in accordance with one embodiment. As seen, the system 100 can include a sharing system 104, an external data share manager 106, a streaming system 102, a data storage system 114, a data sharing channel 110, a third party 112, a data storage system 116, an external data share compliance monitoring system 108, and a compliance dashboard 118.

For example, the sharing system 104 can include a production business application or business user with an intent to share data with the third party 112. To do so, the sharing system 104 can register a data share for the data with the external data share manager 106, a prerequisite of which can include identifying a data producer, a channel, a data consumer, data, and a business purpose for the data share. Indeed, the sharing system 104 can identify the data producer, the channel, the data consumer, the data, and the business purpose for the data share to the external data share manager 106 when requesting a new permit for the data share or when requesting an update to an existing permit for the data share, and the external data share manager 106 can transmit a notification to the sharing system 104 approving, updating, revoking, or rejecting a permit for the data share when applicable. Additionally or alternatively, in some embodiments, the external data share manager 106 can transmit the notification approving, updating, revoking, or rejecting the permit for the data share to the data sharing channel 110, for example, via the streaming system 102. In some embodiments, the streaming system 102 can include data streams to exchange data between different systems or sub-systems in the system 100.

Details for the permit can include an identification of the sharing system 104, a name of the data share, a code for a business purpose of the data share, a description of the business purpose of the data share, content of the data share, including baseline attributes, and an identification of a third party to receive the data share. However, embodiments disclosed herein are not so limited, and the permit can include additional or alternate details as would be understood by one of ordinary skill in the art.

It is to be understood that the external data share manager 106 can revoke a previously approved permit for the data share. For example, when changes to a relationship with the sharing system 104 or the third party 112 occur, such as a status change, a LOB change, a product release, or a contract termination, the external data share manager 106 can update the previously approved permit and transmit notifications thereof.

In some embodiments, the external data share manager 106 can approve, revoke, reject, and/or provide and report notifications and issues regarding permits and can include an inventory system to facilitate registration of data shares. When registering the data share, the external data share manager 106 can validate user input by integrating with the data storage system 114 so that the external data share manager 106 has access to quality data when identifying data that was intended to be shared.

In some embodiments, the external data share manager 106 can transmit the data and/or the data share from the sharing system 104 and/or the permit and/or the details thereof for the data share to the data storage system 114. In this regard, the data storage system 114 can include one or more data storge systems as would be understood by one of ordinary skill in the art. For example, in some embodiments, the data storage system 114 can include a data lake that stores data in one centralized repository for massive amounts of raw data or true source data with flexibility to transform the data into designed data stores for specified business uses. The data lake can act as a storage system for capturing the data when produced by operational systems for downstream analysis. As such, collecting and governing the data in the data lake can enable quick analysis of the data for reporting, aggregation, and machine learning. Additionally or alternatively, the data storage system 114 can store and maintain production business applications and business users, store catalogs of datasets, store metadata for APIs, store human resource data for associates, and/or store strategic sourcing, contract management, and supplier management data.

Systems and methods disclosed herein can integrate data shares on demand or in batch. For example, an on demand integration pattern can include the external data share manager 106 validating the data share when registering the data share. However, metadata in the data share can become stale, for example, when contracts are extended or expired, new terms are added to contracts, and the like. As such, an in batch integration pattern can include the external data share manager 106 consuming changes in the data storage system 114 via the data streams in the streaming system 102 to update the metadata.

When permitted, the sharing system can share data with the third party 112 via the data sharing channel 110. To do so, the data sharing channel 110 can open one or more network IP address and/or port with the third party 112. However, in some embodiments, the sharing system 104 and/or the data sharing channel 110 can ensure that the data is complete prior to the data sharing channel 110 initiating such an intake process. It is to be understood that the data being complete in this regard can include a data share for the data having a valid permit, thereby indicating that all accountable persons, users, and/or systems on the data share have approved the data for the third party 112. When the data is complete, the sharing system 104 can transmit the data to the third party 112 via the data sharing channel 110, and the data sharing channel 110 can transmit metadata for the data share to the data storage system 116 via the streaming system 102 for validation and the like. In this regard, the metadata for the data share can include transmission run-time details, such as, for example, transmission time and/or duration, a name of the data share, an identification of the third party, a volume of the data share, a frequency of the data share, and contents of the data share, including a list of attributes found in the data share. Additionally or alternatively, the data sharing channel 110 can transmit a mirrored copy of the data and/or the data share to the data storage system 116 via the streaming system 102 for validation and the like.

The data storage system 116 can include one or more data storage systems as would be understood by one of ordinary skill in the art. For example, in some embodiments, the data storage system 116 can include a software-as-a service (SaaS) data warehouse, including a third party SaaS data warehouse. In some embodiments, the SaaS data warehouse can be stored and managed on the cloud. For example, the SaaS data warehouse can be implemented on Amazon Web Services, Microsoft Azure, Google Cloud Platform, and the like. In any embodiment, the SaaS data warehouse can enable users to store and analyze data using cloud-based hardware and software and can feature separate compute, storage, and cloud services that can scale independently. For example, the data can be stored on elastic disk storage in the cloud. Separately, compute clusters, such as virtual warehouses, can be dynamically allocated as required to execute queries or data load and can connect to cloud storage when access to the data is based on approved security roles of users. That is, storage and computing need not be tightly coupled together. As such, storage and compute features can grow and be reduced independently of each other.

The external data share compliance monitoring system 108 can receive and/or retrieve data from the data storage system 114 and the data storage system 116 directly and/or via the streaming system 102 and determine whether what is shared with the third party 112 matches what is intended to be shared with the third party 112. In this regard, the external data share compliance monitoring system 108 can compare the data, the data share, the permit, and/or the details of the permit retrieved from the data storage system 114 (i.e. what is intended to be shared) with the metadata for the data share retrieved from the data storage system 116 (i.e. what is shared). When what is shared matches or is within a predetermined threshold of what is intended to be shared, the external data share compliance monitoring system 108 can provide a notification thereof to the compliance dashboard 118 for display thereon to visualize compliance to a user. However, when what is shared fails to match or is outside of a predetermined threshold of what is intended to be shared, the external data share compliance monitoring system 108 can provide a notification thereof to the compliance dashboard 118 for display thereon to visualize non-compliance to the user and/or initiate actions for remediation of the non-compliance.

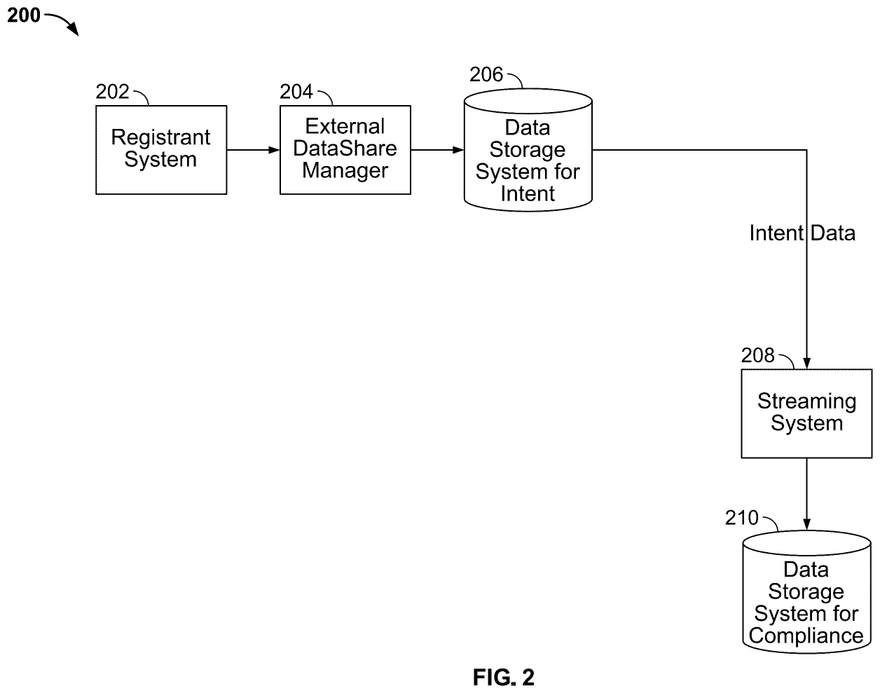

FIG. 2 is a block diagram that illustrates an example of a system 200 in accordance with one embodiment. As seen, the system 200 can include a registrant system 202, an external data share manager 204, a data storage system 206, a streaming system 208, and a data storage system 210. It is to be understood that in some embodiments, the system 200 can be part of and/or the same as or similar to part of the system 100. Similarly, it is to be understood that in some embodiments, the registrant system 202 can be the same as or similar to the sharing system 104, the external data share manager 204 can be the same as or similar to the external data share manager 106, the data storage system 206 can be the same as or similar to the data storage system 114, the streaming system 208 can be the same as or similar to the streaming system 102, and/or the data storage system 210 can be the same as or similar to the data storage system 116.

For example, the system 200 can capture and/or identify a share intent in accordance with disclosed embodiments. In this regard, the registrant system 202 can include an intent to share data with a third party. To do so, the registrant system 202 can register a data share for the data with the external data share manager 204, a prerequisite can include identifying a data producer, a channel, a data consumer, data, and a business purpose for the data share. Indeed, the registrant system 202 can identify the data producer, the channel, the data consumer, the data, and the business purpose for the data share to the external data share manager 204 when requesting a new permit for the data share or when requesting an update to an existing permit for the data share, and the external data share manager 204 can transmit a notification to the registrant system 202 approving, updating, revoking, or rejecting a permit for the data share when applicable.

In some embodiments, the external data share manager 204 can approve, revoke, reject, and/or provide and report notifications and issues regarding permits and can include an inventory system to facilitate registration of data shares. In this regard, the external data share manager 204 can transmit the data and/or the data share from the registrant system 202 and/or the permit and/or the details thereof for the data share to the data storage system 206. When registering the data share, the external data share manager 204 can validate user input by integrating with the data storage system 206 so that the external data share manager 204 has access to quality data when identifying data that was intended to be shared.

In some embodiments, the external data share manager 204 and/or the data storage system 206 can also transmit the data and/or the data share from the registrant system 202 and/or the permit and/or the details thereof for the data storage system to the data storage system 210 for validation and the like, for example, via the streaming system 208. In some embodiments, the streaming system 208 can include data streams to exchange data between different systems or sub-systems in the system 200.

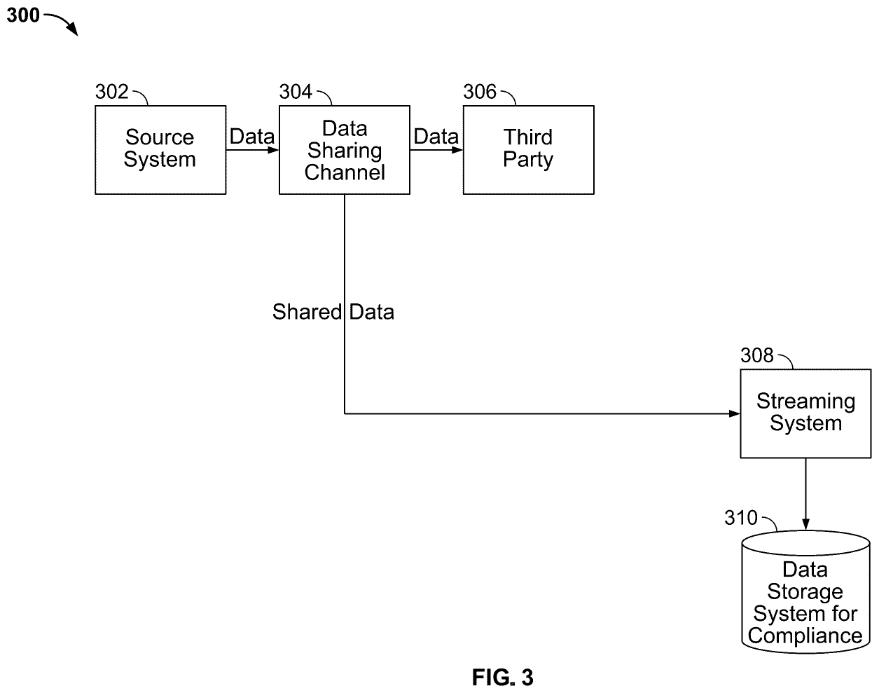

FIG. 3 is a block diagram that illustrates an example of a system 300 in accordance with one embodiment. As seen, the system 300 can include a source system 302, a data sharing channel 304, a third party 306, a streaming system 308, and a data storage system 310. It is to be understood that in some embodiments, the system 300 can be part of and/or the same as or similar to part of the system 100. Similarly, it is to be understood that in some embodiments, the source system 302 can be the same as or similar to the sharing system 104, the data sharing channel 304 can be the same as or similar to the data sharing channel 110, the third party 306 can be the same as or similar to the third party 112, the streaming system 208 can be the same as or similar to the streaming system 102 and/or the streaming system 208, and/or the data storage system 310 can be the same as or similar to the data storage system 116 and/or the data storage system 210.

For example, the system 300 can capture and/or identify data shared in accordance with disclosed embodiments. In this regard, the source system 302 can share data with the third party 306 via the data sharing channel 304. For example, in some embodiments, the data sharing channel 304 can open one or more network IP address and/or port with the third party 112. In some embodiments, the source system 302 and/or the data sharing channel 304 can ensure that the data is complete prior to the data sharing channel 304 initiating such an intake process. It is to be understood that the data being complete in this regard can include a data share for the data having a valid permit, thereby indicating that all accountable persons, users, and/or systems on the data share have approved the data for the third party 306. When the data is complete, the source system 302 can transmit the data to the third party 306 via the data sharing channel 304.

In some embodiments, the source system 302 and/or the data sharing channel 304 can also transmit metadata for the data share to the data storage system 310 via the streaming system 308 for validation and the like. In this regard, the metadata for the data share can include transmission run-time details, such as, for example, transmission time and/or duration, a name of the data share, an identification of the third party, a volume of the data share, a frequency of the data share, and contents of the data share, including a list of attributes found in the data share. Additionally or alternatively, the source system 302 and/or the data sharing channel 304 can transmit a mirrored copy of the data and/or the data share to the data storage system 310 via the streaming system 308 for validation and the like.

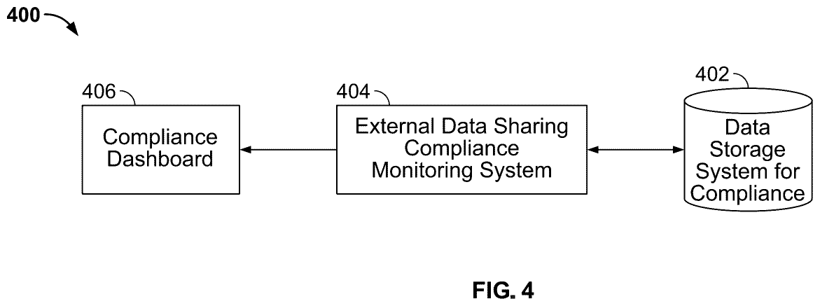

FIG. 4 is a block diagram that illustrates an example of a system 400 in accordance with one embodiment. As seen, the system 400 can include a data storage system 402, an external data share compliance monitoring system 404, and a compliance dashboard 406. It is to be understood that in some embodiments, the system 400 can be part of and/or the same as or similar to part of the system 100. Similarly, it is to be understood that in some embodiments, the data storage system 402 can be the same as or similar to the data storage system 116, the data storage system 210, and/or the data storage system 310, the external data share compliance monitoring system 404 can be the same as or similar to the external data share compliance monitoring system 108, and/or the compliance dashboard 406 can be the same as or similar to the compliance dashboard 118.

For example, the system 400 can determine whether the share intent as identified by the system 200 matches the data shared as identified by the system 300. In this regard, the data storage system 402 can include the data, the data share, the permit, and/or the details of the permit for the share intent as well as the metadata for the data share and/or a mirrored copy of the data and/or the data share. As such, the external data share compliance monitoring system 404 can receive and/or retrieve such data from the data storage system 402 and determine whether what is actually shared matches what is intended to be shared, including, for example, whether what is actually shared is authorized and/or whether drift in the metadata for the data share, volume and frequency anomalies, and/or drift in attribute level data are detected. In this regard, the external data share compliance monitoring system 404 can compare the data, the data share, the permit, and/or the details of the permit retrieved from the data storage system 402 (i.e. what is intended to be shared) with the metadata for the data share and/or the mirrored copy of the data and/or the data share retrieved from the data storage system 402 (i.e. what is shared) to make such determinations.

When what is shared matches or is within a predetermined threshold of what is intended to be shared, the external data share compliance monitoring system 404 can provide a notification thereof to the compliance dashboard 406 for display thereon to visualize compliance to a user. However, when what is shared fails to match or is outside of a predetermined threshold of what is intended to be shared, the external data share compliance monitoring system 404 can provide a notification thereof to the compliance dashboard 406 for display thereon to visualize non-compliance to the user and/or initiate actions for remediation of the non-compliance.

As explained above, in some embodiments, the external data share compliance monitoring system 108 can determine whether the data share is authorized. For example, the external data share compliance monitoring system 108 can determine whether the data share corresponds to a valid permit. Additionally or alternatively, in some embodiments, the external data share compliance monitoring system 108 can determine whether contents of the data share are approved for sharing.

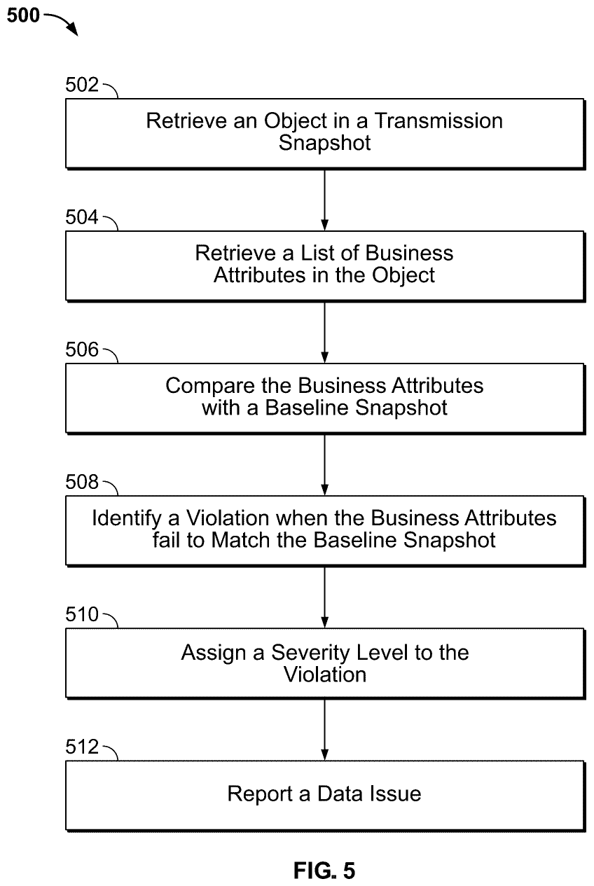

In this regard, FIG. 5 is a flow chart that illustrates an example of a method 500 for determining whether contents of the data share were approved for sharing in accordance with disclosed embodiments. In some embodiments, the external data share compliance monitoring system 108 can execute all or some of the method 500.

As seen, the method 500 can include retrieving an object in a transmission snapshot as in 502 and retrieving a list of business attributes in the object as in 504. For example, the transmission snapshot, the object therein, and/or the list of business attributes in the object can be retrieved from the data storage system 116. In some embodiments, the method 500 can retrieve a list of objects in the transmission snapshot. However, for clarity, the method 500 will be described in connection with a single object.

The method 500 can compare the business attributes in the object with a baseline snapshot as in 506. For example, in some embodiments, the baseline snapshot can be retrieved from the data storage system 114 and/or the external data share manager 106. When the business attributes fail to match the baseline snapshot, the method 500 can identify a violation as in 508. In this regard, it is to be understood that matching can include an exact match or within a predetermined threshold. Then, the method 500 can assign a severity level to the violation as in 510 and report a data issue as in 512, for example, via the compliance dashboard 118.

In accordance with disclosed embodiments, the method 500 can be executed as a detective control and/or as a preventive control. When executed as a detective control, the method 500 can be executed after the data is transmitted to the third party 112. When a violation is identified in the detective control, systems and methods can initiate remediation to address the violation. However, when executed as a preventive control, the method 500 can be executed prior to the data being transmitted to the third party 112. When a violation is identified in the preventive control, systems and methods can prevent the data from being transmitted to the third part 112.

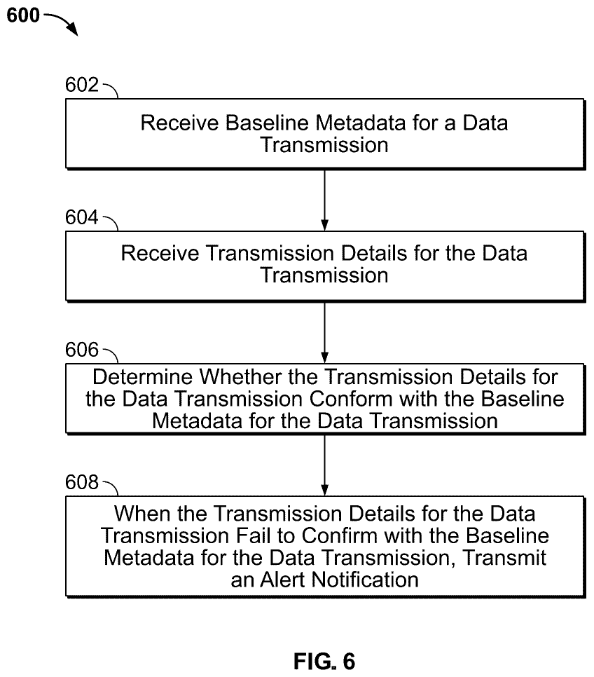

As explained above, systems and methods disclosed herein can be used to detect drift in the metadata of the data share, volume and frequency anomalies, and/or drift in attribute level data. In this regard, FIG. 6 is a flow chart that illustrates an example of a method 600 for detecting drift in the metadata of the data share in accordance with disclosed embodiments. In some embodiments, the external data share compliance monitoring system 108 can execute some or all of the method 600.

The metadata in the data share can become obsolete over some period of time. As such, systems and methods disclosed herein can maintain the accuracy of the data by transmitting an alert or a notification to execute a remediation step when drift is detected. Possible drift scenarios can include the meta data in the data share changing, the meta data in the data share being misaligned with the meta data in the data sharing channel 110, the metadata in the data share being misaligned with stored data, the metadata in the data share being present but without an identification for the data share, the data share lacking a valid permit, the metadata missing a dataset type, and/or the metadata including invalid information.

As seen in FIG. 6, the method 600 can include receiving baseline metadata for a data transmission as in 602 and receiving transmission details for the data transmission as in 604. In some embodiments, the baseline snapshot can be retrieved from the data storage system 114 and/or the external data share manager 106, and in some embodiments, the transmission details can be retrieved from the data storage system 116. In some embodiments, the method 600 can receive the baseline metadata for the data transmission upon registration of the data transmission for external transmission. Additionally or alternatively, in some embodiments, the method 600 can receive the baseline metadata for the data transmission upon creation of the data transmission in a database.

The method 600 can determine whether the transmission details for the data transmission conform with the baseline metadata for the data transmission as in 606, and when the transmission details for the data transmission fail to confirm with the baseline metadata for the data transmission, the method 600 can transmit an alert notification. Conforming, in this regard, can be understood to mean matching exactly or within some predetermined tolerance. In some embodiments, the method 600 can determine whether the transmission details for the data transmission conform with the baseline metadata for the data transmission as in 606 prior to the data transmission being transmitted to a third party. Additionally or alternatively, in some embodiments, the method 600 can determine whether the transmission details for the data transmission conform with the baseline metadata for the data transmission as in 606 after the data transmission is transmitted to the third party.

In some embodiments, the method 600 can also determine whether a data share of the data transmission is authorized. For example, in some embodiments, the method 600 can determine whether the data transmission has a valid permit for transmission thereof.

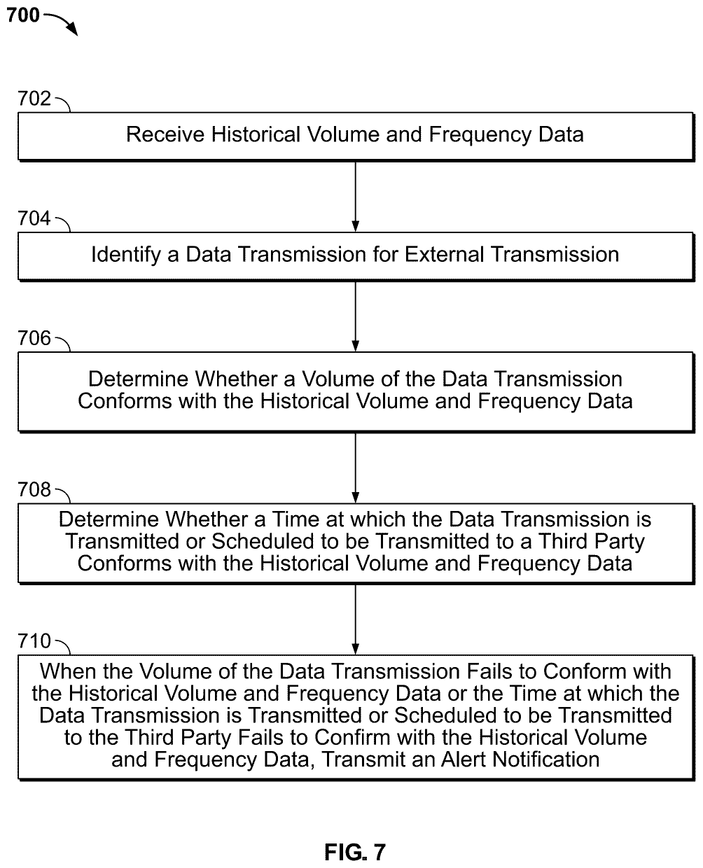

As explained above, systems and methods disclosed herein can be used to detect volume and frequency anomalies. In this regard, FIG. 7 is a flow chart that illustrates an example of a method 700 for detecting volume and frequency anomalies. In some embodiments, the external data share compliance monitoring system 108 can execute some or all of the method 700.

For frequency, systems and methods disclosed herein can identify daily events in a frequency data frame by grouping identifications of transmissions and determining whether a number of times a particular transmission occurred is equal to a difference of a day between a most recent occurrence timestamp and an older occurrence timestamp. Similarly, systems and methods disclosed herein can identify weekly events in the frequency data frame by grouping identifications of transmissions and determining whether a number of times a particular transmission occurred is equal to a difference of a week between a most recent occurrence timestamp and an older occurrence timestamp. Systems and methods disclosed herein can also identify monthly events in the frequency data frame by grouping identifications of transmissions and determining whether a number of times a particular transmission occurred is equal to a difference of a month between a most recent occurrence timestamp and an older occurrence timestamp. Finally, systems and methods disclosed herein can identify yearly events in the frequency data frame by grouping identifications of transmissions and determining whether a number of times a particular transmission occurred is equal to a difference of a year between a most recent occurrence timestamp and an older occurrence timestamp.

For volume, systems and methods disclosed herein can identify all transmission events, sort and group by identifications of the transmission events, and identify a mean or average of a file size for each of the transmission events to identify historical volumes thereof. In some embodiments, the mean can be rounded to a particular place value, such as two decimal places. In some embodiments, systems and methods disclosed herein can also identify a standard deviation for the file size for each of the transmission events to identify historical tolerances thereof. In some embodiments, the standard deviation can be rounded to a particular place value, such as two decimal places. However, in some embodiments, standard deviation need not be identified, for example, when a particular transmission event occurred within a predetermined period of time, thereby signifying that the transmission event is recent or not particularly historic. However, when standard deviation is identified, systems and methods disclosed herein can combine the historical volume and the historical tolerance in a volume data frame with the frequency data frame.

As seen in FIG. 7, the method 700 can include receiving historical volume and frequency data as in 702 and identifying a data transmission for external transmission as in 704. In some embodiments, the historical volume and frequency data can be retrieved from the data storage system 114 and/or the external data share manager 106, and in some embodiments, the data transmission can be retrieved from the data storage system 116. In some embodiments, the method 700 can include receiving a mirrored copy of the data transmission.

The method 700 can determine whether a volume of the data transmission conforms with the historical volume and frequency data as in 706 and determine whether a time at which the data transmission is transmitted or scheduled to be transmitted to a third party conforms with the historical volume and frequency data as in 708. Conforming, in this regard, can be understood to mean matching exactly or within some predetermined tolerance. In some embodiments, the method 700 can determine whether the volume of the data transmission conforms with the historical volume and frequency data prior to the data transmission being transmitted to the third party and determine whether the time at which the data transmission is scheduled to be transmitted to the third party conforms with the historical volume and frequency data prior to the data transmission being transmitted to the third party. Additionally or alternatively, in some embodiments, the method 700 can determine whether the volume of the data transmission conforms with the historical volume and frequency data after the data transmission is transmitted to the third party and determine whether the time at which the data transmission is transmitted to the third party conforms with the historical volume and frequency data after the data transmission is transmitted to the third party.

When the volume of the data transmission fails to conform with the historical volume and frequency data or the time at which the data transmission is transmitted or scheduled to be transmitted to the third party fails to confirm with the historical volume and frequency data, the method 700 can include transmitting an alert notification as in 710.

In some embodiments, the method 700 can also determine whether a data share of the data transmission is authorized. For example, in some embodiments, the method 700 can determine whether the data transmission has a valid permit for transmission thereof.

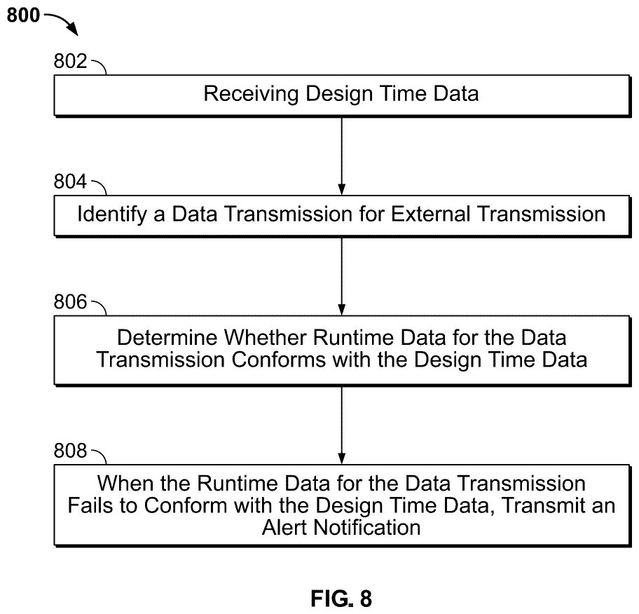

As explained above, systems and methods disclosed herein can be used to detect drift in attribute level data. In this regard, FIG. 8 is a flow chart that illustrates an example of a method 800 for detecting drift in attribute level data. In some embodiments, the external data share compliance monitoring system 108 can execute some or all of the method 800.

Systems and methods disclosed herein can monitor a volume and a frequency of an API shared with a third party and detect mismatches between the volume and/or the frequency of the API intended at design time and the volume and/or the frequency of the API at run-time execution. In this regard, systems and methods disclosed herein can establish connectivity with different systems, such as, for example, the data storage system 114, the data storage system 116, the external data share manager 106, and/or the data sharing channel 110, to matching identifiers of a data transmission.

As seen in FIG. 8, the method 800 can include receiving design time data as in 802 and identifying a data transmission for external transmission as in 804. In some embodiments, the design time data can include volume and frequency data for one or more APIs. In some embodiments, the design time data can be retrieved from the data storage system 114 and/or the external data share manager 106, and in some embodiments, the data transmission can be retrieved from the data storage system 116. In some embodiments, the method 700 can include receiving a mirrored copy of the data transmission.

The method 800 can determine whether runtime data for the data transmission conforms with the design time data as in 806, and when the runtime data for the data transmission fails to conform with the design time data, the method 800 can include transmitting an alert notification as in 808. Conforming, in this regard, can be understood to mean matching exactly or within some predetermined tolerance. In some embodiments, the method 800 can determine whether the runtime data for the data transmission conforms with the design time data while the data transmission is transmitted to a third party. Additionally or alternatively, in some embodiments, the method 800 can include determining whether the runtime data for the data transmission conforms with the design time data after the data transmission is transmitted to the third party.

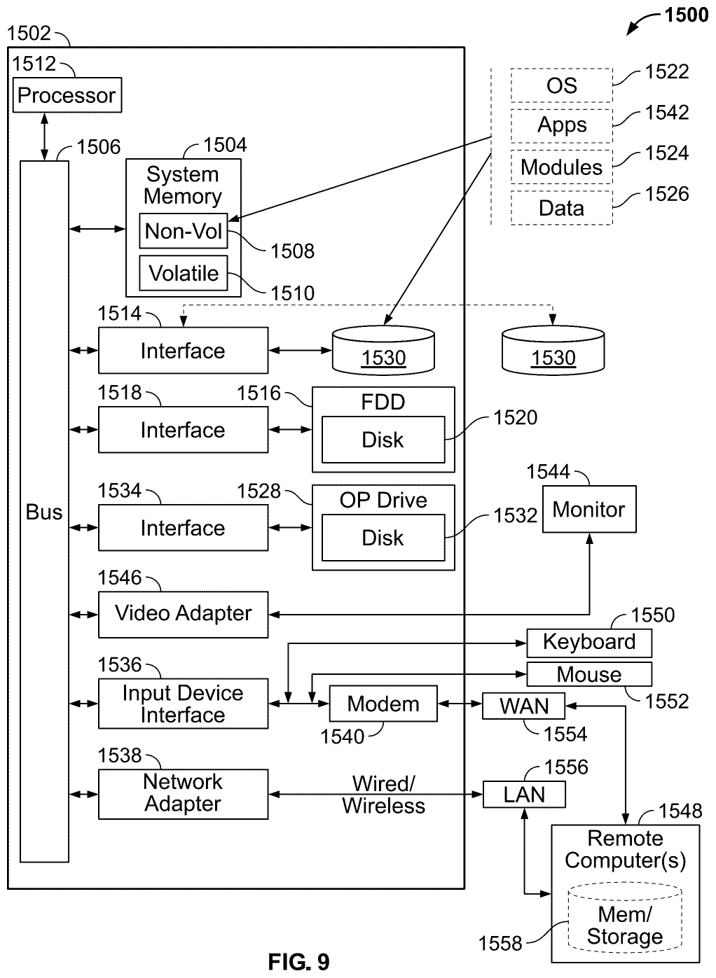

FIG. 9 illustrates an embodiment of an exemplary computer architecture 1500 suitable for implementing various embodiments as previously described. In one embodiment, the computer architecture 1500 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1500.

As shown in FIG. 6, the computing architecture 1500 includes a processor 1512, a system memory 1504 and a system bus 1506. The processor 1512 can be any of various commercially available processors.

The system bus 1506 provides an interface for system components including, but not limited to, the system memory 1504 to the processor 1512. The system bus 1506 can be any of several types of bus structure that may further interconnect to a memory bus (with or without a memory controller), a peripheral bus, and a local bus using any of a variety of commercially available bus architectures. Interface adapters may connect to the system bus 1506 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), Peripheral Component Interconnect (PCI) Express, Personal Computer Memory Card International Association (PCMCIA), and the like.

The computing architecture 1500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1504 may include various types of computer-readable storage media in the form of one or more higher speed memory units, such as ROM, RAM, dynamic RAM (DRAM), Double-Data-Rate DRAM (DDRAM), synchronous DRAM (SDRAM), static RAM (SRAM), programmable ROM (PROM), erasable programmable ROM (EPROM), EEPROM, flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 1504 can include non-volatile 1508 and/or volatile 1510. A basic input/output system (BIOS) can be stored in the non-volatile 1508.

A computer 1502 may include various types of computer-readable storage media in the form of one or more lower speed memory units, including an internal (or external) hard disk drive 1530, a magnetic disk drive 1516 to read from or write to a removable magnetic disk 1520, and an optical disk drive 1528 to read from or write to a removable optical disk 1532 (e.g., a CD-ROM or DVD). The hard disk drive 1530, magnetic disk drive 1516 and optical disk drive 1528 can be connected to system bus 1506 by a hard disk drive (HDD) interface 1514, and a floppy disk drive (FDD) interface 1518, and an optical disk drive interface 1534, respectively. The HDD interface 1514 for external drive implementations can include at least one or both of USB and IEEE 1394 interface technologies.

The drives and associated computer-readable media provide volatile and/or nonvolatile storage of data, data structures, computer-executable instructions, and so forth. For example, a number of program modules can be stored in the drives and non- volatile 1508, and volatile 1510, including an operating system 1522, one or more applications 1542, other program modules 1524, and program data 1526. In one embodiment, the one or more applications 1542, other program modules 1524, and program data 1526 can include, for example, the various applications and/or components of the systems discussed herein.

A user can enter commands and information into the computer 1502 through one or more wire/wireless input devices, for example, a keyboard 1550 and a pointing device, such as a mouse 1552. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1512 through an input device interface 1536 that is coupled to the system bus 1506 but can be connected by other interfaces such as a parallel port, IEEE 1394 serial port, a game port, a USB port, an IR interface, and so forth.

A monitor 1544 or other type of display device is also connected to the system bus 1506 via an interface, such as a video adapter 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all the elements described relative to the computer 1502, although, for purposes of brevity, only a memory and/or storage device 1558 is illustrated. The logical connections depicted include wire/wireless connectivity to a local area network 1556 and/or larger networks, for example, a wide area network 1554. Such LAN and Wide Area Network (WAN) networking environments are commonplace in offices and companies, and facilitate enterprise-wide computer networks, such as intranets, all of which may connect to a global communications network, for example, the Internet.

When used in a local area network 1556 networking environment, the computer 1502 is connected to the local area network 1556 through a wire and/or wireless communication network interface or network adapter 1538. The network adapter 1538 can facilitate wire and/or wireless communications to the local area network 1556, which may also include a wireless access point disposed thereon for communicating with the wireless functionality of the network adapter 1538.

When used in a wide area network 1554 networking environment, the computer 1502 can include a modem 1540, or is connected to a communications server on the wide area network 1554 or has other means for establishing communications over the wide area network 1554, such as by way of the Internet. The modem 1540, which can be internal or external and a wire and/or wireless device, connects to the system bus 1506 via the input device interface 1536. In a networked environment, program modules depicted relative to the computer 1502, or portions thereof, can be stored in the remote memory and/or storage device 1558. It will be appreciated that the network connections shown are exemplary and other means of establishing a communications link between the computers can be used.

The computer 1502 can be operable to communicate with wired and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™M wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASICs), PLDs, DSPs, field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, ASICs, logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

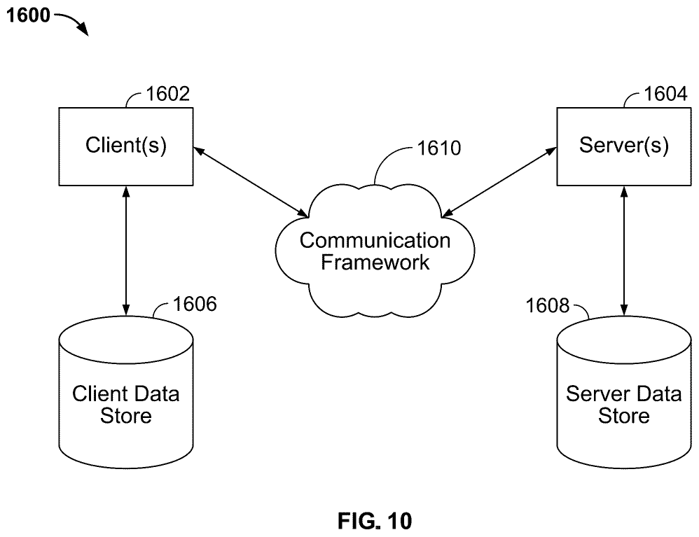

FIG. 10 is a block diagram depicting an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600, which may be consistent with systems and devices discussed herein.

As shown in FIG. 10, the communications architecture 1600 includes one or more client(s) 1602 and server(s) 1604. The server(s) 1604 may implement one or more functions and embodiments discussed herein. The client(s) 1602 and the server(s) 1604 are operatively connected to one or more respective client data store 1606 and server data store 1608 that can be employed to store information local to the respective client(s) 1602 and server(s) 1604, such as cookies and/or associated contextual information.

The client(s) 1602 and the server(s) 1604 may communicate information between each other using a communication framework 1610. The communication framework 1610 may implement any well-known communications techniques and protocols. The communication framework 1610 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1610 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 1602 and the server(s) 1604. A communications network may be any one and the combination of wired and/or wireless networks including without limitation a direct interconnection, a secured custom connection, a private network (e.g., an enterprise intranet), a public network (e.g., the Internet), a PAN, a LAN, a Metropolitan Area Network (MAN), an Operating Missions as Nodes on the Internet (OMNI), a WAN, a wireless network, a cellular network, and other communications networks.

What is claimed is:

1. A method comprising:
receiving baseline metadata for a data transmission;
receiving transmission details for the data transmission;
determining whether the transmission details for the data transmission conforms with the baseline metadata for the data transmission; and
when the transmission details for the data transmission fail to conform with the baseline metadata for the data transmission, transmitting an alert notification.

2. The method of claim 1 further comprising:
determining whether the transmission details of the data transmission conform with the baseline metadata for the data transmission prior to the data transmission being transmitted to a third party.

3. The method of claim 1 further comprising:
determining whether the transmission details for the data transmission conform with the baseline metadata for the data transmission after the data transmission is transmitted to a third party.

4. The method of claim 1 further comprising:
receiving the baseline metadata for the data transmission upon registration of the data transmission for external transmission.

5. The method of claim 1 further comprising:
receiving the baseline metadata for the data transmission upon creation of the data transmission in a database.

6. The method of claim 1 wherein the baseline metadata for the data transmission includes a transmission time, a name, a third party identification, a volume, a frequency, or a list of content attributes for the data transmission.

7. The method of claim 1 further comprising:
determining whether a data share of the data transmission is authorized.

8. The method of claim 7 further comprising:
determining whether the data transmission has a valid permit authorizing the transmission details.

9. A method comprising:
receiving historical volume and frequency data;
identifying a data transmission for external transmission;
determining whether a volume of the data transmission conforms with the historical volume and frequency data;
determining whether a time at which the data transmission is transmitted or scheduled to be transmitted to a third party conforms with the historical volume and frequency data; and
when the volume of the data transmission fails to conform with the historical volume and frequency data or the time at which the data transmission is transmitted or scheduled to be transmitted to the third party fails to confirm with the historical volume and frequency data, transmitting an alert notification.

10. The method of claim 9 further comprising:
receiving a mirrored copy of the data transmission.

11. The method of claim 9 further comprising:
determining whether the volume of the data transmission conforms with the historical volume and frequency data prior to the data transmission being transmitted to the third party; and
determining whether the time at which the data transmission is scheduled to be transmitted to the third party conforms with the historical volume and frequency data prior to the data transmission being transmitted to the third party.

12. The method of claim 9 further comprising:
determining whether the volume of the data transmission conforms with the historical volume and frequency data after the data transmission is transmitted to the third party; and
determining whether the time at which the data transmission is transmitted to the third party conforms with the historical volume and frequency data after the data transmission is transmitted to the third party.

13. The method of claim 9 further comprising:
determining whether a data share of the data transmission is authorized.

14. The method of claim 13 further comprising:
determining whether the data transmission has a valid permit for transmission thereof.

15. A method comprising:
receiving design time data;
identifying a data transmission for external transmission;
determining whether runtime data for the data transmission conforms with the design time data; and
when the runtime data for the data transmission fails to conform with the design time data, transmitting an alert notification.

16. The method of claim 15 further comprising:
receiving a mirrored copy of the data transmission.

17. The method of claim 15 further comprising:
determining whether the runtime data for the data transmission conforms with the design time data while the data transmission is transmitted to a third party.

18. The method of claim 15 further comprising:
determining whether the runtime data for the data transmission conforms with the design time data after the data transmission is transmitted to the third party.

19. The method of claim 15 wherein the design time data includes volume and frequency data for one or more application programming interfaces (APIs).

20. The method of claim 19 further comprising:
determining whether the runtime data for transmitting the data transmission via the one or more APIs conforms with the volume and frequency data for the one or more APIs.
